(19) United States
(12) Patent Application Publication
(10) Pub. No.: US 2006/0131364 A1
(43) Pub. Date: Jun. 22, 2006

(54) Friction plug welding method for a hole in a metal part, use of a restraint part and supporting part for implementing the method

(75) Inventors: Bernard Bouet, Gretz-Armainvilliers (FR); Jean-Pierre Ferte, Corbeil Essonnes (FR); Olivier Jean-Marie Gourbesville, La Celle Saint Cloud (FR); Didier Bruno Le Saunier, Torcy (FR)

Correspondence Address: OBLON, SPIVAK, MCCLELLAND, MAIER & NEUSTADT, P.C., 1940 DUKE STREET, ALEXANDRIA, VA, 22314, US

(73) Assignees: SNECMA MOTEURS, Paris (FR); SNECMA SERVICES, Paris (FR)

(21) Appl. No.: 11/113,100

(22) Filed: Apr. 25, 2005

(30) Foreign Application Priority Data
Apr. 27, 2004 (FR) 04 04428

(51) Int. Cl. B23K 20/12

(52) U.S. Cl. 228/112.1

(57) ABSTRACT

The invention relates to a friction plug welding method for a hole in a metal part, opening out onto a front surface and a back surface of the part, in which a rotational metal bar is inserted into the hole, on its front side, to be friction welded. The method according to the invention is characterised in that a restraint part, comprising a cavity, is placed on the back side of the part during friction welding. The method according to the invention authorises the welding of fast softening materials whilst ensuring a support for the weld mix.

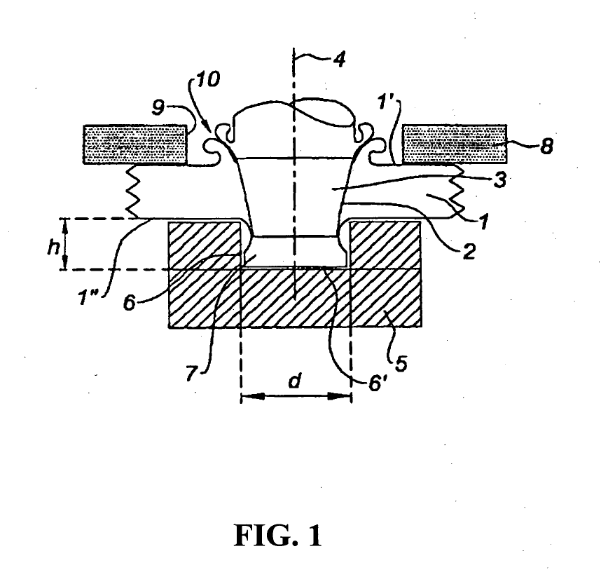

The invention relates to a friction plug welding method, for a hole in a metal part.

Friction plug welding is used for plugging holes in a metal part, generally circular holes emerging from both sides of the part, frustoconical or cylindrical in shape. This method is used when it is desired to limit the loss of mechanical characteristics, with respect to the mechanical characteristics of the original part, in the plugging area of the hole.

A metal bar, generally of the same nature as the material forming the part, is rotated and inserted, under the action of a driven force, into the hole to be plugged, the part containing the latter remaining immobile.

The frictions between the bar and the wall of the hole of the part cause heating of both materials, plasticizing then welding thereof into solid phase. Two pads are formed on each side of the part. It then suffices to machine the bar and the pads on each side of the part to return the part to its original shape, with its hole plugged.

With fast softening materials of low melting temperature, such as aluminium alloys, notably of thickness less than 12 mm, in the first stages of melting the bar and the part, the sudden rise in temperature of the material engenders its very fast softening. This softening leads to a complete loss of rigidity in the part in the locality of the hole. The force applied to the bar in the direction of the part can not be reduced quickly enough at the time of a loss of rigidity in the part; the bar will therefore be prone to piercing the part.

All the same, the welding can be performed but with excessive penetration of the bar. This will result in indentations, cracks, pores and blowholes in the welding area, a distortion of the part and therefore a loss of the mechanical characteristics of the part in the welding area. That is why the friction plug welding method is normally avoided for aluminium alloys, notably for thickness of less than 12 mm.

The invention proposes to overcome these inconveniences.

In this view, the invention relates to a friction plug welding method for a hole in a metal part, opening out onto a front face and a back face of the part, in which a rotational metal bar is inserted into the hole, on its front side, to be friction welded, characterised in that a restraint part, comprising a cavity, is placed on the back side of the part during friction welding.

Advantageously, a support part is placed on the front side of the part.

The invention relates particularly to a friction plug welding method, for a hole in a flange, of aluminium alloy, of a turbojet engine, but it goes without saying that the applicant does not intend to limit the extent of its rights to that sole application.

The invention also relates to the use, for implementing the friction plug welding method of a restraint part and a support part.

The invention will be understood better using the following description of the preferred embodiment of the method according to the invention, with reference to the sole figure representing a schematic section view of the main elements implemented in the method according to the invention.

The method of the invention applies to a metal part, here a flange in a turbojet engine 1 made of aluminium alloy, wherein a hole 2 is to be plugged. In this view, a hole, which has become out of round, on a flange is to be plugged, while keeping mechanical properties close to those of the basic material, in order to be re-drilled, once plugged, to adopt a correct shape. To that effect, a hole friction plug welding method is used.

Generally, the degraded hole, here out of round, has been machined previously, in order to confer a cylindrical or frustoconical shape thereto. This new hole, here the hole 2 that is to be plugged, extends generally along an axis perpendicular to the surface of the part, preferably along the same axis along which the original hole extended. Thus, the whole degraded surface of the hole is eliminated, to render it cylindrical or frustoconical, while minimising the volume of matter removed.

The hole 2 is here frustoconical in shape. Its portion of maximum diameter lying on a face which will be considered as the front face 1′ of the flange 1 and its portion of minimum diameter lying on the back face 1″ of the flange 1.

In the friction plug welding method, a metal bar 3, here made of aluminium alloy, extending along an axis 4, is rotated around its axis 4 and is friction welded, under the action of a driven force, in solid phase, to the flange 1. The metal bar 3 comprises an end portion, frustoconical in shape, whose taper corresponds to that of the hole 2. This method can be implemented according to various operating modes, notably according to a mode known as “driven friction” or a mode known as “inertial friction”.

In both modes, a first stage consists, under pre-set pressure, in contacting the bar 3 and the wall of the hole 2 in order to determine the exact position of the contact between both, the flange 1 remaining fixed throughout the method. The bar 3 is moved accordingly, along its axis 4, perpendicular to the face of the flange 1 in the vicinity of the hole 2, on the front face 1′ side of the flange 1. Thus, the portion of the bar 3 with the smallest diameter is inserted through the portion of the hole 2 with the biggest diameter, then the bar 3 is moved until the frustoconical surfaces of the bar 3 touch the hole 2. Once the contact position has been determined, the bar 3 is brought to its starting position, i.e. a few millimetres recessed from the wall of the hole 2 of the flange 1.

In the case of the ‘driven friction’ mode, the bar 3, driven into rotation on its axis 4, and the wall of the hole 2 are contacted and heated mutually by friction, under the action also of a force applied to the bar 3, along its axis 4, towards the flange 1. After a certain heating-up time, determined by those skilled in the art, an additional axial force is applied, while the rotation is slowed down. The rotation of the bar 3 is decelerated until it stops, typically within 0.2 to 0.8 second and depends on the deceleration ability of the driving machine of the bar 3. Friction welding is then performed, while the axial force applied is maintained after the rotation of bar 3 has stopped, to ensure good welding quality.

In the case of ‘inertial friction’, the bar 3 is placed similarly in starting position and driven into rotation. When it is brought into contact rotation, its rotational driving motor is declutched, so that the energy stored in the rotating system, via the rotational speed and the inertia wheel of the motor, which has been set and sized previously, is dissipated in the welding as in the ‘driven friction’ mode.

The operating modes described above are well known to those skilled in the art and will not be described further. They have been given only for illustrative purposes to facilitate the understanding of the invention, but are not limitative of the operating mode chosen for hole friction plug welding according to the invention. There exist other operating modes which might be implemented.

Irrespective of the chosen operating mode, the method according to the invention stands out from those of the prior art through the use of a restraint part 5, which is contacted with the back face 1″ of the flange 1, prior to welding and is held in place throughout this operation. This restraint part 5 is in the form of any given support whose shape is adapted to the part to be plugged, in this case the flange 1. It can either be attached to the flange 1 via a supporting and putting into contact mechanism or act as a support to the flange 1, as in this case. This restraint part 5 is rigid and its melting point is greater than that of the materials used in the bar 3 and/or the flange 1; in this case it is in steel and in the shape of a plate 5.

It goes without saying that the restraint part 5 can be placed on the back side of the flange 1 right at the beginning of welding or during the latter at an extemporaneous moment. Moreover, those skilled in the art can choose not to make it fully touch. However that may be, it appears that the preferred method consists in placing the restraint part 5 against the back surface of the flange 1 prior to welding and holding it in place throughout this operation.

The restraint part 5 comprises a cylindrical cavity 6, which is placed in line with the hole 2, of the flange 1. The bottom surface 6′ of this cavity acts as an axial stop limit for the bar 3. Thus, when the bar 3 is pressed against the flange 1, heating due to the friction engenders a plasticizing of the materials and, due to the applied axial force, a forward movement of the bar 3 in the hole 2; this forward movement is restricted by the stop limit of the bar 3 onto the bottom 6′ of the cavity 6. Furthermore, the gap defined by the cavity 6 allows to contain the weld mix, that being the mix of heated materials of the bar 3 and of the flange 1, which does not escape. The upset metal 7 created by the welding is then contained in the cavity 6 and cooled down in the latter.

The rotating of the bar 3 in the hole 2, associated with the workability of the welding materials and with the retaining function fulfilled by the restraint part 5 on the back side of the flange 1, as much in the vicinity of the hole 2, in the cavity 6, as on the portion of the surface of the flange 1 surrounding the hole 2 and touching the restraint part 5, can engender a screw effect making the workable welding materials to rise along the bar 3, on the front side of the flange 1. In order to prevent such a phenomenon, a support part 8 is contacted with the front surface of the flange 1. This support part 8 is in the shape of a plate 8, pierced in its centre by a passage recess 9, allowing the bar 3 to pass through. The exact dimensions of this recess 9 are chosen by those skilled in the art according to the operating parameters and the desired dimensions of the upset metal 10 created on the front side of the flange 1. The plate 8 is made in steel in this instance.

The cavity 6 is here cylindrical, with a depth h and a diameter d. The depth here refers to the height of the cylinder which constitutes the shape of the cavity 6. The dimensions of the cavity 6 are chosen according to the thickness of the flange 1 and the dimensions of its hole 2, according to the expected welding, and will be fixed experimentally by those skilled in the art. By way of example, the applicant has discovered that proper welding was obtained, for a hole measuring 10 mm in diameter and 5 mm in thickness, with a cavity measuring 14 mm in diameter and 4 to 5 mm in thickness.

Generally, it is desirable that the diameter of the cavity is at least equal to 1.3 times the back diameter of the hole to be plugged and the depth of the cavity is between 60% and 110% of the thickness of the hole.

Thus, the method of the invention, employing a restraint part 5 and a support part 8, allows to ensure a counter force against the applying force of the bar 3 against the part 1 to be plugged, which could therefore be constant, to prevent an untimely passing of the bar 3 into the hole 2, to contain the stream of upset metal 7, 10 of the welding, to contain the welding energy in the vicinity of the weld, and therefore to limit the distorting of the parts to be plugged and to avoid pores, indentations, cracks and other blowholes from forming.

Once the welding has finished, the heat treatment can ensure the mechanical properties of the part to be plugged are preserved, the latter being machined so as to return to its initial shape, with its hole now plugged.

The method of the invention has been described in relation to a part to be plugged, made of aluminium alloy, but it goes without saying that it applies to any type of alloy, in particular nickel, titanium or iron alloys. It has been described moreover in relation to a bar of the same nature as the part to be plugged, but a bar of different nature may be used. Finally, the restraint and the support parts can be made in steel or any other material inert to the material of the part to be plugged, in the implementation conditions of the method.

1. Friction plug welding method for a hole in a metal part, opening out onto a front surface and a back surface of the part, in which a rotational metal bar is inserted into the hole, on its front side, to be friction welded, characterised in that a restraint part, comprising a cavity, is placed on the back side of the part during friction welding.

2. Method set forth in claim 1, in which the restraint part is contacted with the back surface of the part.

3. Method set forth in claim 1, in which the cavity is placed in line with the hole.

4. Method set forth in claim 1, in which the cavity is cylindrical in shape.

5. Method set forth in claim 4, in which the cylindrical cavity comprises a diameter (d) at least equal to 1.3 times the back diameter of the hole and a depth of between 60% and 110% of the thickness of the hole.

6. Method set forth in claim 1, in which the restraint part comprises a plate made in steel or any other material inert to the material of the part to be plugged.

7. Method set forth in claim 1, in which a support part is placed on the front side of the part during friction welding.

8. Method set forth in claim 7, in which the support part is contacted with the front surface of the part.

9. Method set forth in claim 7, in which the support part comprises a recess for the bar to pass through.

10. Method set forth in claim 7, in which the support part comprises a plate made in steel or any other material inert to the material of the part to be plugged.

11. Method set forth in claim 1, in which the part comprises an aluminium alloy, of nickel, titanium or iron.

12. Use of a restraint part in a friction plug welding method for a hole, set forth in claim 1, the restraint part comprising a plate comprising a cylindrical cavity.

13. Use of a restraint part set forth in claim 12, in which the plate is made of steel or any other material inert to the material of the part to be plugged.

14. Use of a support part in a friction plug welding method for a hole, set forth in claims 1 to 11, the support part comprising a plate pierced by a recess.

15. Use of a support set forth in claim 14, in which the plate is made of steel or any other material inert to the material of the part to be plugged.
